(19) United States
(12) Patent Application Publication
(10) Pub. No.: US 2012/0227913 A1
(43) Pub. Date: Sep. 13, 2012

(54) POLYGONAL DRUM FOR CONTROLLING BLIND SLATS

(76) Inventor: Tser Wen CHOU, Taipei City (TW)

(21) Appl. No.: 13/044,348

(22) Filed: Mar. 9, 2011

(51) Int. Cl. E06B 9/38

(52) U.S. Cl. 160/176.1 R

(57) ABSTRACT

A polygonal drum for controlling blind slats is pivotally connected with a control bar in a blind tilt mechanism for adjusting the angle of the blind slats or controlling opening/closing the blind slats. The polygonal drum includes an elongated equilateral polygonal drum body having multiple plane sidewalls with equal area. The plane sidewalls form the periphery of the elongated equilateral polygonal drum body for winding/unwinding a ladder string by equal length. Accordingly, the blind slats can be easily stably operated and adjusted without obstacle. The polygonal drum further includes multiple reinforcement ribs perpendicularly extending from inner faces of the plane sidewalls to integrally connect with a control bar passage. The reinforcement ribs serve to increase the strength of the polygonal drum so as to overcome the problem of deformation of the conventional control drum.

### BACKGROUND OF THE INVENTION

1. Field of the Invention

The present invention relates to a polygonal drum for adjusting the angle of blind slats and controlling opening/closing the blind slats.

2. Description of the Related Art

A conventional blind has a control bar connected with a pull cord for opening/closing the blind slats. A control drum is mounted on the control bar and the connection string of the blind is connected with the blind slats and fixedly connected with the control drum. By means of rotating the control bar, the control drum is driven and rotated to wind/unwind the connection string for opening/closing the blind slats. For example, U.S. Pat. Nos. 2,589,846, 4,484,612, 4,494,593, 4,821,789, 5,538,068, 7,258,297, 6,527,034, 6,321,820 and 6,279,642 disclose some conventional control drum structures. Such control drum structure has an upper plane sidewall and two lateral arcuate sidewalls. The upper plane sidewall is formed with fixing holes for fixing the connection string. The lateral arcuate sidewalls serve to support the connection string. However, the arcuate sidewalls have an arc length longer than the length of the plane sidewall and lack any support point. As a result, in operation, it is uneasy to for the control drum to lift the connection string. Therefore, it is laborious and unsmooth to operate the control drum and a user often has an obstructive feeling when operating the control drum. Moreover, the connection string tends to slip down for lack of support point.

### SUMMARY OF THE INVENTION

It is therefore a primary object of the present invention to provide a control polygonal drum with enhanced blind slat control effect. The polygonal drum has multiple plane sidewalls with equal length and equal area for more smoothly operating the polygonal drum and controlling opening/closing of the blind slats to save strength. The polygonal drum overcomes the problems of obstructive feeling and slippage of the connection string in operation of the conventional control drum.

To achieve the above and other objects, the polygonal drum of the present invention includes an elongated equilateral polygonal drum body having multiple plane sidewalls forming the periphery of the polygonal drum. In the elongated equilateral polygonal drum body, at least four reinforcement ribs perpendicularly extend from inner faces of the plane sidewalls and converge to connect with a control bar passage. A control bar is fitted through the control bar passage for driving and rotating the elongated equilateral polygonal drum body.

One of the plane sidewalls is formed with two opposite tapered fitting holes. Each tapered fitting hole includes a larger receiving hole and a smaller binding hole in communication with the receiving hole. The tapered fitting holes are arranged in reverse directions for fixedly connecting the ladder string with the elongated equilateral polygonal drum body. The bulged ends of the ladder string are inlaid and fixedly received in the binding holes.

A locating slot is formed on another plane sidewall opposite to the plane sidewall with the tapered fitting holes for drivingly connecting with a ladder tape with a different width. The ladder tape can be passed through the locating slot and fixed therein by means of a fixing rod.

The present invention can be best understood through the following description and accompanying drawings, wherein:

### BRIEF DESCRIPTION OF THE DRAWINGS

FIG. 1 is a sectional view showing a polygonal drum of a prior patent of this applicant;

FIG. 2 is a sectional view showing a conventional control drum structure;

FIG. 3 is a perspective view of the present invention;

FIG. 4 is a side view of the present invention;

FIG. 5 is a sectional view showing the installation of the ladder string of the present invention;

FIG. 6 is a perspective view of the present invention, showing the locating slot thereof;

FIG. 7 is a perspective view showing the installation of the present invention;

FIG. 8 is a sectional view showing the installation of the present invention;

FIG. 9 is a sectional view showing the force distribution of the present invention;

FIG. 10 is a view showing that the plane sidewalls of the present invention have equal lengths;

FIG. 11 is a sectional view showing the operation of the present invention; and

FIG. 12 is a view of another embodiment of the present invention.

### DETAILED DESCRIPTION OF THE PREFERRED EMBODIMENTS

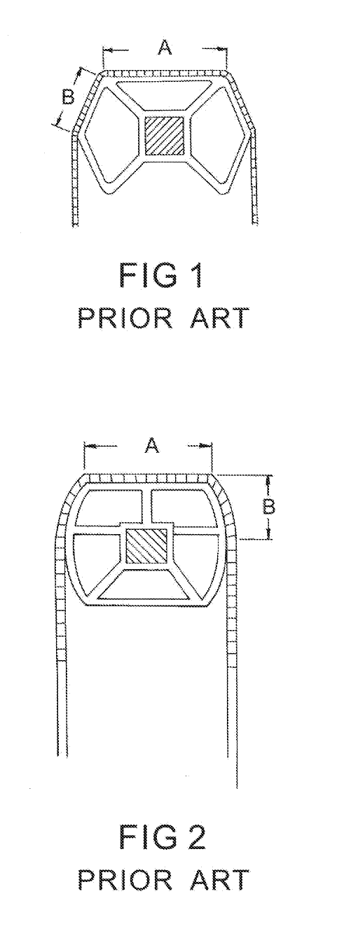

Please refer to FIG. 1, which shows a polygonal drum of a prior patent of this applicant. The polygonal drum has an upper plane sidewall with a length A and two lateral plane sidewalls with a length B. The length A is unequal to the length B. As a result, the polygonal drum can be hardly smoothly operated. FIG. 2 shows a conventional control drum structure having two plane sidewalls and two arcuate sidewalls. After the ladder string is installed, the length A of the ladder string on the plane sidewall will be larger than the length B of the ladder string on the arcuate sidewall. This will deteriorate the smoothness in operation of the ladder string. Moreover, the arcuate sidewalls cannot support the ladder string so that the drum body can be hardly precisely controlled and it is quite laborious to operate the drum body. Therefore, such control drum cannot provide better use effect.

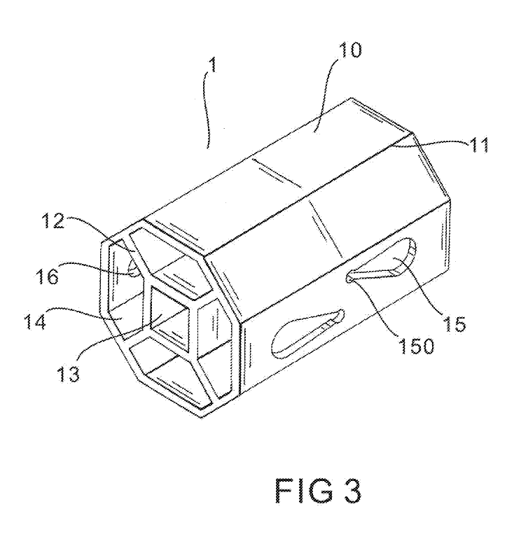

Please refer to FIG. 3, which is a perspective view showing the structure of the polygonal drum of the present invention. The polygonal drum includes an elongated equilateral polygonal drum body 1 having multiple plane sidewalls 10 forming the periphery of the elongated equilateral polygonal drum body 1. The plane sidewalls 10 are connected with each other by a predetermined angle to define multiple angles 11. The number of the angles 11 is equal to that of the plane sidewalls 10. In the elongated equilateral polygonal drum body 1, four reinforcement ribs 12 perpendicularly extend from inner faces of the plane sidewalls 10 and converge to connect with a control bar passage 13. Accordingly, multiple chambers 14 are defined in the elongated equilateral polygonal drum body 1 with the same capacity and configuration. A control bar 4 is fitted through the control bar passage 13 (also with reference to FIG. 5).

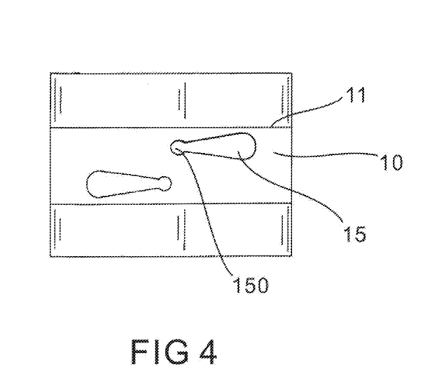

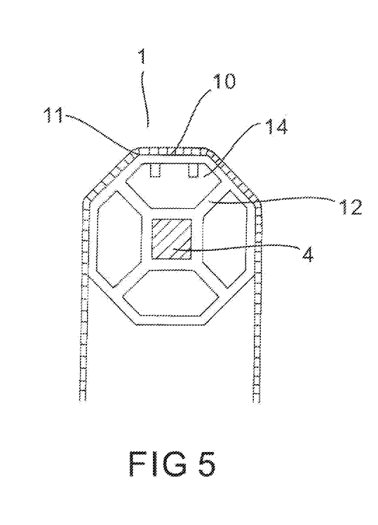

One of the plane sidewalls 10 is formed with two tapered fitting holes for fixedly connecting the ladder string with the elongated equilateral polygonal drum body 1 (as shown in FIGS. 3 and 4). Each tapered fitting hole includes a larger receiving hole 15 and a smaller binding hole 150 in communication with the receiving hole 15. The tapered fitting holes are arranged in reverse directions for fixedly connecting the ladder string with the elongated equilateral polygonal drum body 1 (as shown in FIG. 5).

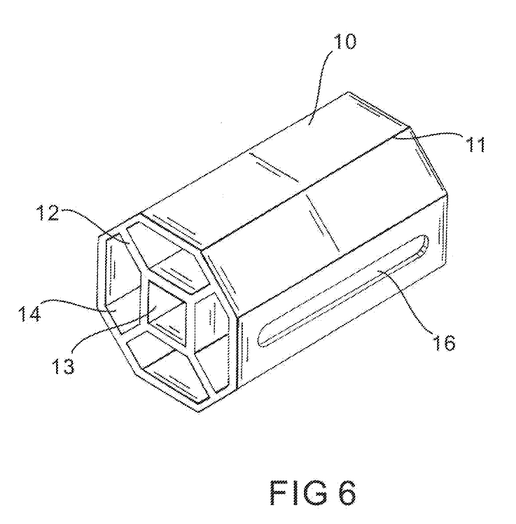

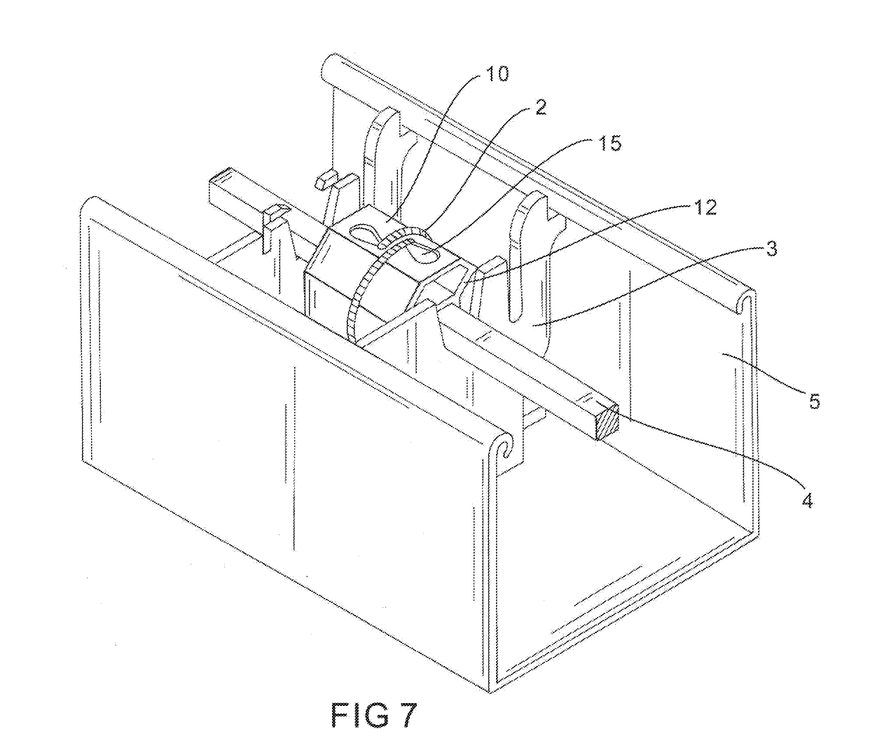

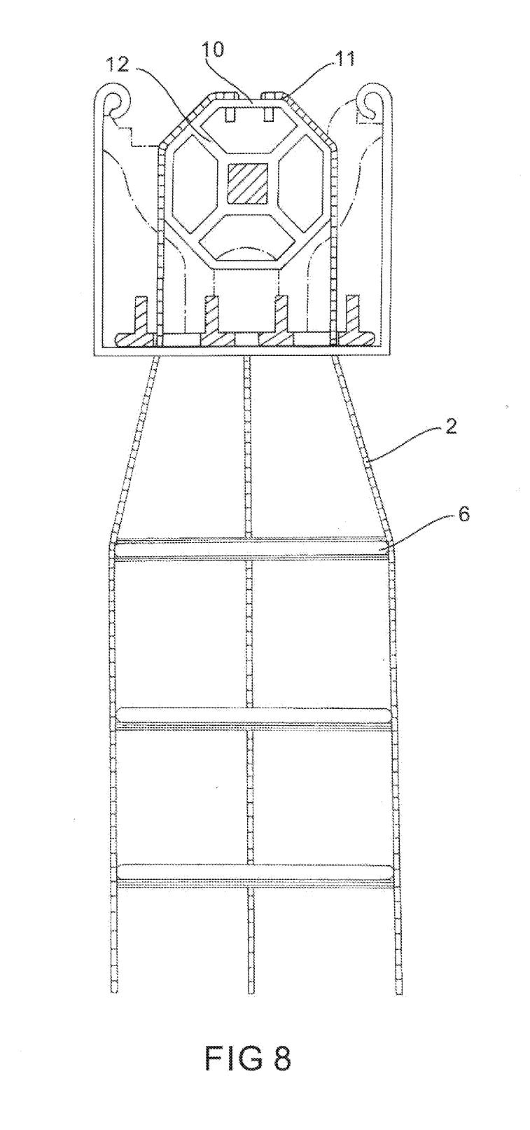

A locating slot is formed on another plane sidewall opposite to the plane sidewall with the tapered fitting holes for drivingly connecting with a ladder tape with a different width (as shown in FIG. 6). The ladder tape can be passed through the locating slot and fixed therein by means of a fixing rod (not shown) for different usage. Please refer to FIGS. 7 and 8, the polygonal drum of the present invention is pivotally connected with the control bar 4 in a horizontal blind tilt mechanism and fixedly arranged in a blind rail 5 via a fixing seat 3. The ladder string 2 is engaged in the tapered fitting holes and suspended from the elongated equilateral polygonal drum body 1 to connect with multiple blind slats 6 for controllably opening/closing the blind slats 6 (as shown in FIG. 8).

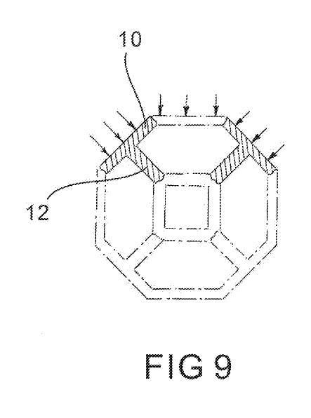

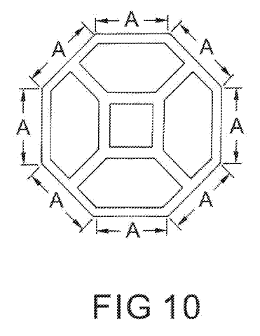

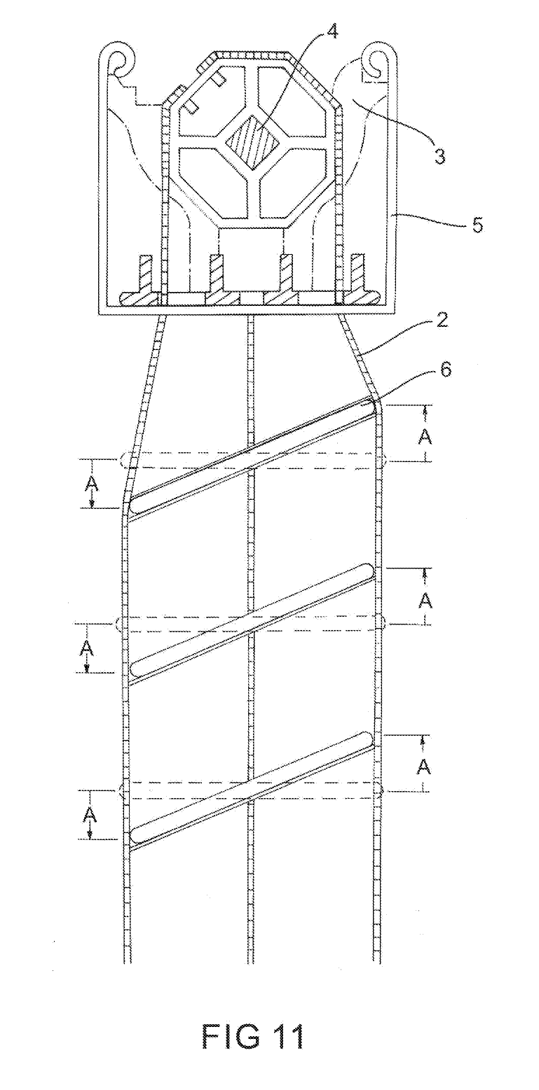

When a user pulls a pull cord to rotate the control bar 4, due to the weight of the blind slats 6, a maximum gravity is applied to the upper plane sidewall of the elongated equilateral polygonal drum body 1 (as shown in FIG. 9). The reinforcement ribs 12 perpendicularly extending from the inner faces of the plane sidewalls 10 serve to prevent the elongated equilateral polygonal drum body 1 from being deformed. Moreover, the plane sidewalls 10 of the elongated equilateral polygonal drum body 1 have equal lengths A (as shown in FIG. 10) so that the blind slats 6 will ascend and descend by equal distances A. This can reduce unsmoothness in operation of the blind. Also, the angles 11 contained between the plane sidewalls serve to support the ladder strings to facilitate the operation (as shown in FIG. 11).

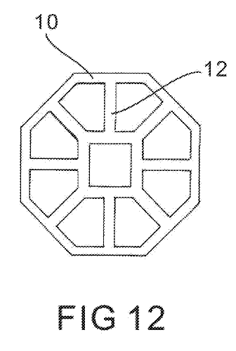

FIG. 12 shows another embodiment of the polygonal drum of the present invention. In this embodiment, a reinforcement rib 12 extends from the inner face of each plane sidewall 10 to enhance the strength of the elongated equilateral polygonal drum body 1.

The above embodiments are only used to illustrate the present invention, not intended to limit the scope thereof. Many modifications of the above embodiments can be made without departing from the spirit of the present invention.

What is claimed is:

1. A polygonal drum for controlling blind slats, the polygonal drum being pivotally connected with a control bar in a horizontal blind tilt mechanism, the polygonal drum being controllable to wind/unwind ladder strings of the blind for adjusting the angle of the blind slats or opening/closing the blind slats, the polygonal drum comprising:
an elongated equilateral polygonal drum body having multiple plane sidewalls forming a periphery of the elongated equilateral polygonal drum body, the plane sidewalls defining a substantially hollow interior of the polygonal drum;
a control bar passage axially extending through a center of the equilateral polygonal drum body for receiving therein a corresponding polygonal control bar in the horizontal blind tilt mechanism;
a hollow latticed body including at least four reinforcement ribs sequentially defining at least four chambers with the same capacity and configuration;
a pair of tapered fitting holes formed on one of the plane sidewalls opposite to each other, each tapered fitting hole including a larger receiving hole and a smaller binding hole, bulged ends of the ladder string being correspondingly inlaid and fixedly received in the binding holes; and
a locating slot formed on another plane sidewall opposite to the plane sidewall with the tapered fitting holes, said polygonal drum being characterized in that the plane sidewalls of the elongated equilateral polygonal drum body have equal areas and are connected with each other by a predetermined angle to define multiple angles, the number of the angles being equal to that of the plane sidewalls, in the elongated equilateral polygonal drum body, the reinforcement ribs perpendicularly extending from middle sections of inner faces of the plane sidewalls to integrally connect with the control bar passage to form the polygonal drum.

2. The polygonal drum for controlling blind slats as claimed in claim 1, wherein the number of the plane sidewalls is larger than 2 but smaller than or equal to 12.

3. The polygonal drum for controlling blind slats as claimed in claim 2, wherein the number of the plane sidewalls is preferably 8 to form a regular octagonal drum body.

4. The polygonal drum for controlling blind slats as claimed in claim 1, wherein the chambers defined by the reinforcement ribs axially extend through the elongated equilateral polygonal drum body.

5. The polygonal drum for controlling blind slats as claimed in claim 1, wherein the bulged ends of the ladder string are passed over the elongated equilateral polygonal drum body and fixedly inlaid in the opposite tapered fitting holes.
